(19) United States
(12) Patent Application Publication
(10) Pub. No.: US 2023/0097642 A1
(43) Pub. Date: Mar. 30, 2023

(54) PLANT PROTECTION AGENT

(71) Applicant: RUST GMBH, Brüttisellen (CH)

(72) Inventors: Rudolf STECK, Brüttisellen (CH); Werner HÄNSELER, Brüttisellen (CH); Roland MÜNTENER, Nürensdorf (CH)

(73) Assignee: RUST GMBH, Brüttisellen (CH)

(21) Appl. No.: 17/801,023

(22) PCT Filed: Feb. 9, 2021
(86) PCT No.: PCT/EP2021/053079

§ 371 Date: Aug. 19, 2022

(30) Foreign Application Priority Data
Feb. 19, 2020 (CH) 00184/20

(51) Int. Cl. A01N 65/28; A01N 65/34

(52) U.S. Cl. CPC A01N 65/28; A01N 65/34

(57) ABSTRACT

A plant protecting agent for combatting plant pathogens, including an active substance soluble in water, to provide a plant protecting agent which is particularly gentle on humans and the environment and at the same time has good efficacy against plant pathogens. The plant protecting agent includes as active substances a first fraction (A) based on the cannabis plant (Cannabis Sativa L.) and a second fraction (B) based on the tea tree plant (Melaleuca alternifolia), and a third fraction (C) of distilled water, the first and second fractions (A; B) being present in the third fraction (C) as an extract.

### TECHNICAL FIELD

The present invention describes a plant protecting agent and a process for preparing the plant protecting agent.

### BACKGROUND

A large number of plant protecting agents (also referred to generally as pesticides) are known that are used for combatting plant pathogens that cause plant diseases on plant seeds and/or plants themselves and thus to prevent or minimise the threat of yield losses that led to famines in earlier times. Depending on the type of plant pathogen involved, i.e. a bacterium, a fungus or a virus, the plant protecting agent is referred to as fungicidal, bactericidal or virucidal. Furthermore, plant protecting agents or pesticides can be designated as acaricidal, avicidal, herbicidal, insecticidal, miticidal, molluscicidal, nematicidal or rodenticidal. Known plant protecting agents or pesticides can contain organic or inorganic active substances. Furthermore, plant protecting agents or pesticides can contain, alternatively or additionally, chemical substances that have a plant-strengthening effect and thus act indirectly against plant pathogens.

In many cases, the plant pathogen is a fungus or its spores, as in the case of so-called downy mildew in grapes (fungus: Plasmopara viticola) or in the case of so-called apple scab in apples (fungus: Venturia inaequalis), the plant protecting agent being referred to here as a fungicide.

Plant protecting agents or fungicides containing synthetically prepared active substances are available on the market. Such plant protecting agents or fungicides based on synthetically prepared active substances have multiple disadvantages, such as a reduction in the effect on the plant pathogens (i.e. so-called development of resistance) as well as undesirable environmental influences, for example in bodies of water, and possibly also undesirable influences on humans.

Some commercially available plant protecting agents therefore contain active substances based on the metals copper or potassium instead of synthetic active substances, i.e. in this case inorganic active substances. One such known copper-containing plant protecting agent is, for example, Kocide Opti. Such a known potassium-containing plant protecting agent is, for example, Armicarb.

Such plant protecting agents containing copper or potassium have the disadvantage that excessive accumulation of these metals in soils or bodies of water can place a strain on humans and the environment.

Document WO 2016/004326 A1, for example, describes a plant protecting agent which contains natural substances, i.e. substances that only occur in nature, as active substances and is thus intended to be gentle on humans and the environment. In this case, the natural active substance is constituted by compositions based on the essential oils of a wide variety of plants, with a fungicidal effect against the plant-pathogenic fungi Pythium aphani dermatum (root rot in soybeans, beets, peppers, cucurbits) and Rhizoctonia solani (potato pox) being described.

However, the plant protecting agent known from document WO 2016/004326 A1 has the disadvantage that extraction agents are necessarily used in the production of essential oils and therefore potentially harmful substances may, in turn, be released into the environment.

### SUMMARY

The object of the present invention is to provide a plant protecting agent which is particularly gentle on humans and the environment and at the same time has good efficacy against plant pathogens.

In accordance with the invention, the plant protecting agent comprises, as active substances, a first fraction based on the cannabis plant (Cannabis Sativa L. and/or Cannabis Indica) and a second fraction based on the tea tree plant (Melaleuca alternifolia), as well as a third fraction of a liquid, in particular distilled water, the first and second fractions being present in the third fraction as an extract (maceration). As an alternative to distilled water or in addition, alcohol and/or an oil can also be used as a third fraction, whereby it is advantageous to dissolve out hydrophobic constituents or to accelerate and intensify the extract. In this alternative variant, oil in the form of plant oil based on rapeseed, thistle and/or MTC oil (for example coconut oil) is particularly preferred.

For the purposes of the present invention, an extract based on the cannabis plant or hemp plant (i.e. Cannabis Sativa L. and/or Cannabis Indica) is understood to mean that in particular hemp waste without flowers in a pure untreated state, preferably from indoor cultivation, is to be used. Furthermore, in the sense of the present invention, an extract (maceration) based on the tea tree plant (i.e. Melaleuca alternifolia) is understood to mean that the tea tree plant parts are present in a pure, untreated state, the parts of the tea tree plant being preferably merely dried with a dry substance of 80% to 100% before the extraction process. In a preferred development of the present invention, the extraction may be implemented in the form of a “cold extraction” or a “hot extraction”, or a combination of pressure and heat.

According to the definition from Wikipedia, the term “cold extraction” is understood to mean a so-called maceration or a cold water extraction, with this preparation process advantageously allowing highly volatile or thermally unstable ingredients to be separated from raw plant materials. In this process, comminuted plant material is poured over cold to lukewarm water, left to stand for a relatively long period of time, and the liquid part, known as the “cold extract”, is strained from the solid constituents.

It has advantageously been shown that the plant protecting agent according to the invention is particularly suitable as a fungicide, especially against the pathogenic fungi Venturia inaequalis (apple scab) and/or Plasmopara viticola (downy mildew). A further advantage that can be cited is that a practically harmless plant protecting agent has been obtained which is gentle on the environment and humans, fulfils the requirements of a natural organic product, and, due to the simplicity of the dosing, can be used by hobby gardeners as well as by industrial users in organic farming.

In a preferred development, the plant protecting agent according to the invention is used as a spraying agent, i.e. is finely sprayed onto the parts of the plant in question that is to be treated.

Alternatively to a “cold” extraction, a “hot” extraction is conceivable in accordance with a preferred development of the present invention, in which an extract can be obtained by the application of supplied heat and/or pressure to the first fraction based on the cannabis plant (Cannabis Sativa L. and/or Cannabis Indica), the second fraction based on the tea tree plant (Melaleuca alternifolia) and the third fraction of a liquid, in particular distilled water, with the first and second fractions being present in the third fraction as an extract or at least partially dissolved. Advantageously, it has been shown that an extract can be realised hereby in a particularly short time. Furthermore, in accordance with a particularly preferred development of the present invention, it is conceivable that the third fraction of liquid, in particular water, is removed from the obtained extract by the application of heat and pressure in order to increase the concentration of the first and second fractions.

Further advantageous embodiments are described in the dependent patent claims.

Preferably, the plant protection agent according to the invention additionally comprises a wetting agent, the wetting agent comprising a rapeseed oil derivative or the like, in particular a hydrogenated or hardened rapeseed oil derivative or the like. The addition of such a wetting agent advantageously ensures that the plant protecting agent according to the invention retains its efficacy despite periods of rain or other weather conditions. The wetting agent can be the rapeseed oil derivative “Codacide” containing 95 wt. % rapeseed oil and 5 wt. % polyethoxylated ester as emulsifier. Preferably, the addition of such a wetting agent in conjunction with the plant protecting agent according to the invention is determined depending on the country and local or meteorological conditions.

In a preferred further development of the present invention, the plant protecting agent according to the invention may comprise the wetting agent in a suitable concentration or, alternatively, may be added to the plant protecting agent according to the invention by the end user in this suitable concentration as required.

Preferably, the plant protecting agent according to the invention is present as a concentrate with a third, distilled water fraction of 80 wt. % to 98 wt. %, more preferably of 85 to 95 wt. %, even more preferably about 90 wt. %, so that the plant protecting agent is suitable for industrial use. In other words, the plant protecting agent according to the invention can alternatively be diluted or pre-dosed to a concentration suitable for immediate use by hobby gardeners or private individuals. For example, a concentrate is conceivable which is present in a mixing ratio of 1:4 (i.e. 20 wt. % of the first and second fractions and 80 wt. % of the third fraction). In accordance with a further example, in other words, for immediate use, the plant protecting agent according to the invention could be present in a mixing ratio of 1:49 (i.e. 2 wt. % of the first and second fractions and 98 wt. % of the third fraction).

Another aspect of the present invention relates to a process for preparing a plant protecting agent, comprising the process steps:
a) providing a first fraction based on the cannabis plant and a second fraction based on the tea tree plant;
b) comminuting the first and second fractions to a predetermined degree of grinding, for example with the aid of a mortar or the like;
c) adding a third fraction of a liquid, in particular distilled water;
d) allowing the mixture obtained in process step c) to stand for a predetermined extraction period, preferably in particular in a cold extraction process of more than 15 days, preferably between 3 and 6 weeks;
e) separating the solid, undissolved constituents of the first and second fractions from the mixture obtained in process step d), for example with the aid of a sieve and/or a mechanical press;
   so that a cold extraction process for obtaining a cold extract from the cannabis plant and the tea tree plant is realised.

By using the process according to the invention, a very simple preparation of an effective plant protecting agent, i.e. with only a few simple items of equipment, can be realised.

Preferably, after process step e) of the process according to the invention, the cold extract obtained is pasteurised or sterilised, preferably at a temperature between 60° C. and 110° C., in order to prevent microbial degradation processes and to increase the shelf life of the resulting plant protecting agent.

According to a further preferred development of the present invention, a fourth fraction based on green or white lavender (Lavandula viridis) is additionally provided or comminuted in process steps a) and b).

According to yet another preferred development, a fifth fraction (E) based on true lavender (Lavandula angustfolia) is additionally provided or comminuted in process steps a) and b), with the first, second and fifth fractions (A; B; E) being present in the third fraction (C) as an extract.

### BRIEF DESCRIPTION OF THE DRAWINGS

A preferred exemplary embodiment of the subject matter of the invention will be described below in conjunction with the accompanying drawings, in which:

FIG. 1 shows a schematic illustration of the process steps for preparing the plant protecting agent according to the invention;

FIG. 2 shows a graph illustrating the efficacy of the plant protecting agent according to the invention against the plant pathogen Plasmopara viticola (downy mildew) in terms of disease incidence compared with a reference product;

FIG. 3 shows a graph illustrating the efficacy of the plant protecting agent according to the invention against the plant pathogen Plasmopara viticola (downy mildew) in terms of disease severity compared with a reference product;

FIG. 4 shows another graph illustrating the percentage efficacy against the plant pathogen Plasmo para viticola of the investigated plant protecting agent according to the invention in terms of disease severity compared with the reference product;

FIG. 5 shows a graph showing the efficacy of the plant protecting agent according to the invention against the plant pathogen Venturia inaequalis (apple scab) in terms of disease frequency in comparison with two reference products;

FIG. 6 shows a graph illustrating the efficacy of the plant protecting agent according to the invention against the plant pathogen Venturia inaequalis (apple scab) in terms of disease severity in comparison with two reference products;

FIG. 7 shows another graph showing the percentage efficacy of the investigated plant protecting agent according to the invention against the plant pathogen Venturia inaequalis (apple scab) in terms of disease severity in comparison with the two reference products.

### DETAILED DESCRIPTION

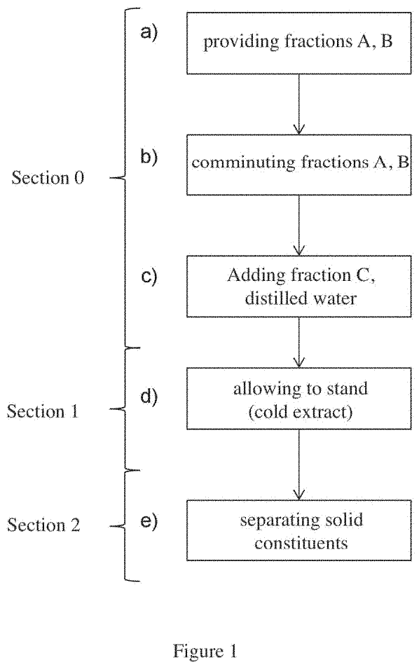

FIG. 1 shows, by way of example, a schematic illustration of the process steps for preparing the plant protecting agent according to the invention. This preferred variant of a process for preparing a plant protecting agent comprises the process steps:
a) providing a first fraction A based on the cannabis plant and a second fraction B based on the tea tree plant;
b) comminuting the first and second fractions A and B to a predetermined degree of grinding, for example with the aid of a mortar or the like, and transferring them into a container;
c) adding a third fraction C, distilled water, to the container;
d) allowing the mixture obtained in process step c) to stand for a predetermined extraction period, preferably, in particular in a cold extraction process, of more than 15 days, preferably between 3 and 6 weeks;
e) separating the solid, undissolved constituents of fractions A and B from the mixture obtained in process step d), for example with the aid of a sieve and/or a mechanical press;
   so that a cold extract process for obtaining the plant protecting agent according to the invention in the form of a cold extract based on the cannabis plant as well as on the tea tree plant is realised.

In this case, the process steps a) to c) can be combined under one section 0, in which the essential fractions A, B and C are provided in a container and prepared for the actual cold extraction process. In section 1, the actual cold extraction process takes place with process step d), which is concluded in section 2 with the separation of the solid, undissolved constituents of fractions A and B.

Preferably, in process step d), the mixture is left to stand at a temperature between 16° C. to 35° C., more preferably about 30° C.

Particularly preferably, process step e) comprises two successive steps, in which first the dissolved, liquid constituents of the mixture obtained in process step d) are transferred through a fine sieve into a further container and then the remaining, substantially solid constituent of the mixture obtained in process step d) is separated from additional dissolved, liquid constituents by means of a mechanical or hydraulic press and transferred into the further container.

The present invention is further illustrated by the following non-limiting examples:

### Example 1

The plant protecting agent according to the invention was tested for use as a fungicide against downy mildew (Plasmopara viticola) on grape plants of the variety “Chasselas” based on the following, particularly preferred composition (see Table 1) and was evaluated in respect of efficacy.

TABLE 1

| Component | Content |
|---|---|
| Fraction A (tea tree plant) | 25 g to 65 g |
| Fraction B (cannabis plant) | 30 g to 70 g |
| Fraction C (distilled water) | 1,000 ml |

Furthermore, the experimental set-up for EXAMPLE 1 was chosen according to the following Table 2:

TABLE 2

| Equipment | Setting |
|---|---|
| Number of plants per treatment | 6 |
| Treatments: | |
| 0.5 d pre-inoc | |
| 2 d pre-inoc | |
| 0.5 d pre-inoc with artificial | |
| irrigation | |
| Tested fungicides/concentration: | |
| blind control | |
| Kocide Opti Standard | Water |
| Kocide Opti diluted | |
| SVH-Evol Standard (plant | |
| protecting agent according | |
| to the invention) | |
| SVH-Evol diluted | |
| Automatic spraying unit: | |
| Spray time | 14 seconds |
| Spray nozzle pressure | approx. 1.2 bar |
| Spray quantity/treatment | 80 to 100 ml |
| Inoculation: | |
| Spore density (spore-density/ml) | 50,000 sp/ml (outer, abaxial surface |
| | of all fully formed leaves) |
| Incubation: | |
| Level I | 20° C.; light conditions: 16 h |
| | daylight, 8 h night over 6 days |
| Level II | |
| Stage III (after inoculation) | 24 hrs. at a relative humidity of 100% |
| | and 21° C. (16 h daylight, 8 h night) |
| Level IV | 24 h after inoculation: 20° C. (16 h |
| | daylight, 8 h night), 6 days |
| Level V (stimulation of spore | 24 h at a relative humidity of 100% |
| formation) | and 21° C. (16 h daylight, 8 h night) |

The term “0.5 d pre-inoc” is understood here to mean: The grape plants were treated with the tested plant protecting agent according to the invention and the dry leaves were inoculated subsequently (i.e. after about 5 to 8 hours post-treatment). After post-treatment, the grape plants were immediately incubated for 24 hours at a relative humidity of 100%.

The term “2 d pre-inoc” is understood here to mean: The grape plants were treated twice with the tested plant protecting agent according to the invention and the dry leaves were inoculated only two days later.

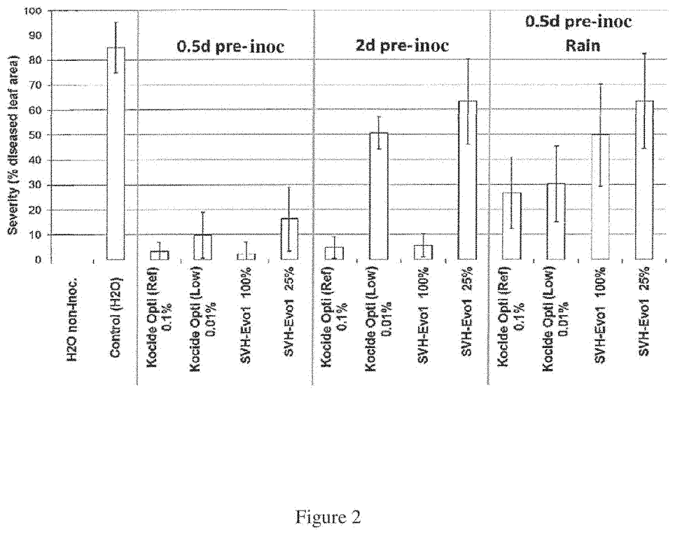

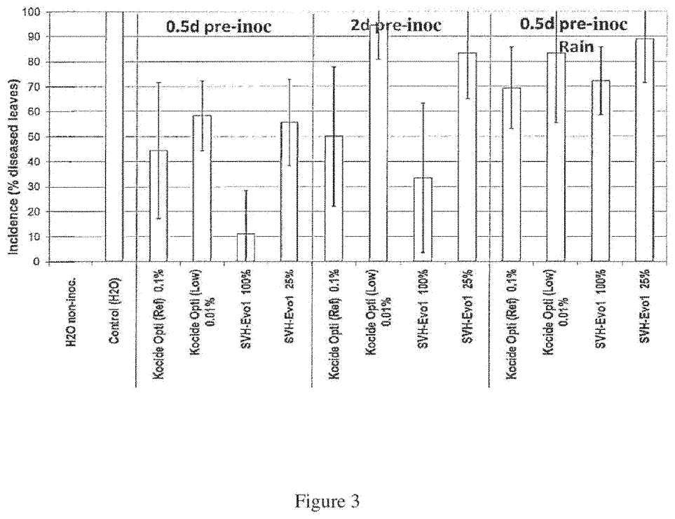

The antimicrobial and antifungal efficacy of the plant protecting agents investigated in EXAMPLE 1 against the plant pathogen Plasmopara viticola was assessed as follows: on the one hand, the percentage of leaves with disease symptoms was determined (disease incidence) as shown in FIG. 2, and, on the other hand, the percentage of dead leaf surface was determined (disease severity) as shown in FIG. 3.

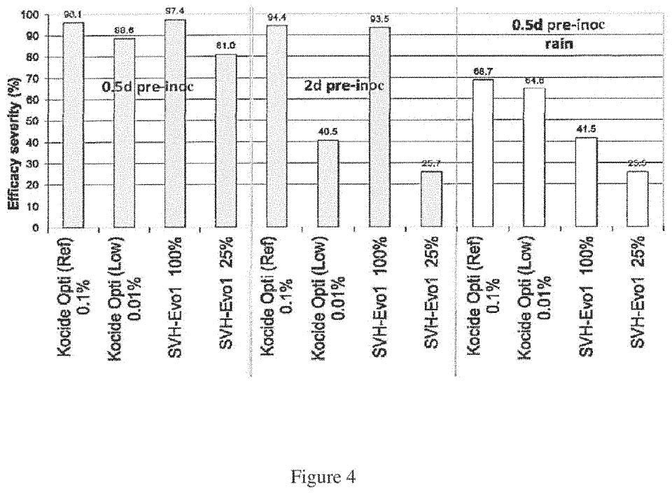

Furthermore, FIG. 4 shows a further graph of the percentage efficacy against the plant pathogen Plasmopara viticola of the investigated plant protecting agent according to the invention in respect of disease severity in comparison with the reference product.

The following Tables 3 and 4 show the efficacy of the plant protecting agent according to the invention (referred to here as SVH-Evo1) in comparison with the commercially available Kocide Opti (containing copper), which is effective against the plant pathogen Plasmopara viticola.

The results on disease severity obtained in EXAMPLE 1 are summarised in Table 3 below:

TABLE 3

| | | | | | Average |
|---|---|---|---|---|---|
| | | | | | disease |
| Treatment | Conc. | Inoculation | Rain | Number | incidence |
| Blind control | N/A | | N/A | 6 | |
| H2O | | | | | |
| Kocide Opti | 0.1% | 0.5 d pre-inoc | No | 6 | 96.1% |
| Standard | | | | | |
| Kocide Opti | 0.01% | 0.5 d pre-inoc | No | 6 | 88.6% |
| diluted | | | | | |
| SVH-Evol | 100% | 0.5 d pre-inoc | No | 6 | 97.4 |
| Standard | | | | | |
| SVH-Evol | 25% | 0.5 d pre-inoc | No | 6 | 81.0% |
| diluted | | | | | |
| Kocide Opti | 0.1% | 2 d pre-inoc | No | 6 | 94.4% |
| Standard | | | | | |
| Kocide Opti | 0.01% | 2 d pre-inoc | No | 6 | 40.5% |
| diluted | | | | | |
| SVH-Evol | 100% | 2 d pre-inoc | No | 6 | 93.5% |
| Standard | | | | | |
| SVH-Evol | 25% | 2 d pre-inoc | No | 6 | 25.7% |
| diluted | | | | | |
| Kocide Opti | 0.1% | 0.5 d pre-inoc | Yes | 6 | 68.7% |
| Standard | | | | | |
| Kocide Opti | 0.01% | 0.5 d pre-inoc | Yes | 6 | 64.6% |
| diluted | | | | | |
| SVH-Evol | 100% | 0.5 d pre-inoc | Yes | 6 | 41.5% |
| Standard | | | | | |
| SVH-Evol | 25% | 0.5 d pre-inoc | Yes | 6 | 25.5% |
| diluted | | | | | |

The results on disease incidence obtained in EXAMPLE 1 are summarised in Table 4 below:

TABLE 4

| | | | | | Average |
|---|---|---|---|---|---|
| | | | | | disease |
| Treatment | Conc. | Inoculation | Rain | Number | incidence |
| Blind control | N/A | | N/A | 6 | |
| H2O | | | | | |
| Kocide Opti | 0.1% | 0.5 d pre-inoc | No | 6 | 55.6% |
| Standard | | | | | |
| Kocide Opti | 0.01% | 0.5 d pre-inoc | No | 6 | 41.7% |
| diluted | | | | | |
| SVH-Evol | 100% | 0.5 d pre-inoc | No | 6 | 88.9% |
| Standard | | | | | |
| SVH-Evol | 25% | 0.5 d pre-inoc | No | 6 | 44.4% |
| diluted | | | | | |
| Kocide Opti | 0.1% | 2 d pre-inoc | No | 6 | 50.0% |
| Standard | | | | | |
| Kocide Opti | 0.01% | 2 d pre-inoc | No | 6 | 5.6% |
| diluted | | | | | |
| SVH-Evol | 100% | 2 d pre-inoc | No | 6 | 66.7% |
| Standard | | | | | |
| SVH-Evol | 25% | 2 d pre-inoc | No | 6 | 16.7% |
| diluted | | | | | |
| Kocide Opti | 0.1% | 0.5 d pre-inoc | Yes | 6 | 30.6% |
| Standard | | | | | |
| Kocide Opti | 0.01% | 0.5 d pre-inoc | Yes | 6 | 16.7% |
| diluted | | | | | |
| SVH-Evol | 100% | 0.5 d pre-inoc | Yes | 6 | 27.8% |
| Standard | | | | | |
| SVH-Evol | 25% | 0.5 d pre-inoc | Yes | 6 | 11.1% |
| diluted | | | | | |

In summary, it can thus be said that the plant protecting agent according to the invention shows an efficacy of 97.4% against the plant pathogen Plasmopara viticola. Furthermore, it has been shown that, even when diluted to a quarter of this concentration recommended for use, an efficacy of 81% is still achieved against the plant pathogen Plasmopara viticola.

When the tested plant protecting agents were applied or sprayed two days before inoculation, only a slight loss of activity was observed, i.e. the tested plant protecting agent “SVH-Evo1” according to the invention showed a reduction in effectiveness comparable to the copper-containing reference product “Kocide Opti”.

In addition, it was shown that, at the concentration recommended for use, the plant protecting agent according to the invention achieves approximately the same efficacy against the plant pathogen Plasmopara viticola as the reference product “Kocide Opti”.

Thus, it could be shown on the basis of EXAMPLE 1 that the plant protecting agent according to the invention can be effectively used against downy mildew, i.e. against the plant pathogen Plasmopara viticola.

Furthermore, it has been shown advantageously that when the dry leaves of the plants are inoculated only two days later after having been sprayed with the plant protecting agent according to the invention, no loss of efficacy can be observed in comparison with the reference product “Kocide Opti”, which means that the plant protecting agent according to the invention can be described as stable.

### Example 2

The plant protecting agent according to the invention was further tested for use as a fungicide against apple scab (Venturia inaequalis) in apples of the variety “cv. Jonagold” based on the following composition (see Table 5) and evaluated in respect of efficacy.

TABLE 5

| Component | Content |
|---|---|
| Fraction A (tea tree plant) | 25 g to 65 g |
| Fraction B (cannabis plant) | 30 g to 70 g |
| Fraction C (distilled water) | 1,000 ml |

Furthermore, the experimental set-up for EXAMPLE 2 was chosen according to Table 6 below:

TABLE 6

| Equipment | Setting |
|---|---|
| Number of plants per treatment | 6 |
| Treatments: | |
| 0.5 d pre-inoc | |
| 2 d pre-inoc | |
| 0.5 d pre-inoc with artificial | |
| irrigation | |
| Tested fungicides/concentration: | |
| blind control | |
| Kocide Opti Standard | Water |
| Kocide Opti diluted | |
| Armicarb Standard | |
| Armicarb diluted | |
| SVH-Evol Standard (plant | |
| protecting agent according | |
| to the invention) | |
| SVH-Evol diluted | |
| Automatic spraying unit: | |
| Spray time | 14 seconds |
| Spray nozzle pressure | Approx. 1.2 bar |
| Spray quantity/treatment | 80 to 100 ml |
| Inoculation: | |
| Spore density (spore-density/ml) | 70,000 sp/ml (outer, abaxial surface |
| | of all fully formed leaves) |
| Incubation: | |
| Level I | |
| Level II | |
| Level III (after inoculation) | 24 h. at a relative humidity of 100% |
| | and 21° C. (16 h daylight, 8 h night) |
| Level IV | 24 h after inoculation: 20° C. (16 h |
| | daylight, 8 h night), 6 days |
| Level V (stimulation of spore | 24 h at a relative humidity of 100% |
| formation) | and 21° C. (16 h daylight, 8 h night) |

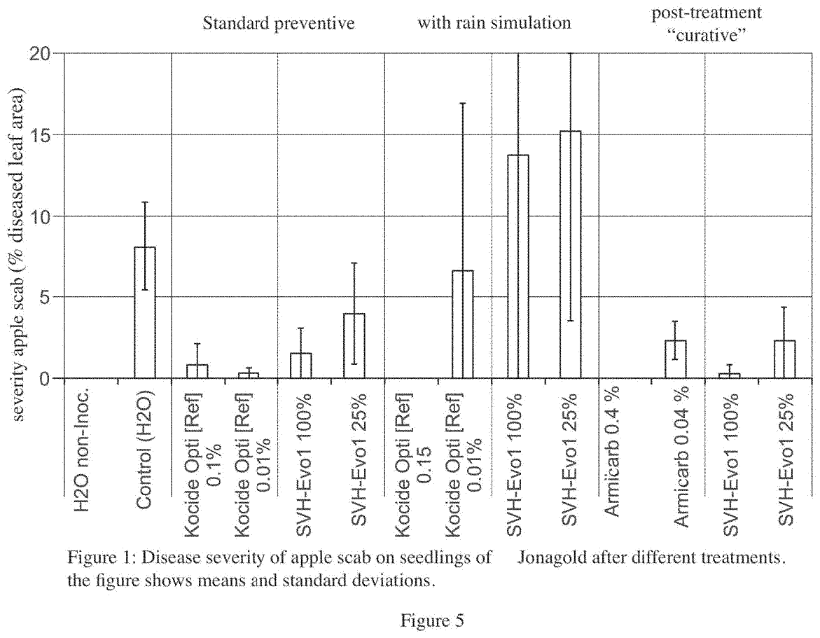

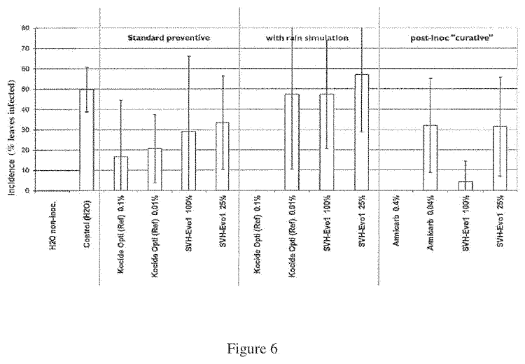

The antimicrobial efficacy of the plant protecting agents investigated in EXAMPLE 2 against the plant pathogen Venturia inaequalis was assessed as follows: on the one hand, the percentage of leaves with disease symptoms was determined (disease incidence) as shown in FIG. 5, and, on the other hand, the percentage of dead leaf surface was determined (disease severity) as shown in FIG. 6.

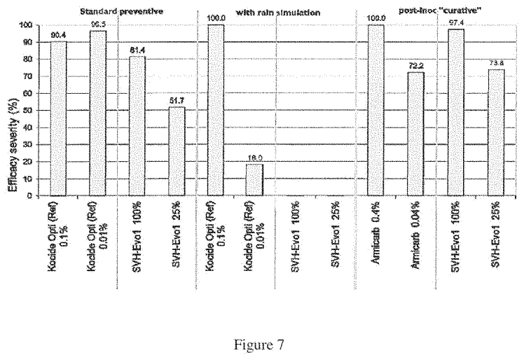

Furthermore, FIG. 7 shows a further graph illustrating the percentage efficacy of the investigated plant protecting agent according to the invention in respect of disease severity in comparison with the two reference products.

The following Tables 3 and 4 show the efficacy of the plant protecting agent according to the invention (referred to here as SVH-Evo1) in comparison with the commercially available Kocide Opti (containing copper) and Armicarb (containing potassium), which are effective against the plant pathogen Venturia inaequalis.

The results obtained in EXAMPLE 2 for disease severity are summarised in Table 3 below:

| | | | | | Average |
|---|---|---|---|---|---|
| | | | | | disease |
| Treatment | Conc. | Inoculation | Rain | Number | incidence |
| Blind control | N/A | | N/A | 6 | |
| H2O | | | | | |
| Kocide Opti | 0.1% | 0.5 d pre-inoc | No | 6 | 90.4% |
| Standard | | | | | |
| Kocide Opti | 0.01% | 0.5 d pre-inoc | No | 6 | 96.5% |
| diluted | | | | | |
| SVH-Evol | 100% | 0.5 d pre-inoc | No | 6 | 81.4% |
| Standard | | | | | |
| SVH-Evol | 25% | 0.5 d pre-inoc | No | 6 | 51.7% |
| diluted | | | | | |
| Kocide Opti | 0.1% | 0.5 d pre-inoc | No | 6 | 100.0% |
| Standard | | | | | |
| Kocide Opti | 0.01% | 0.5 d pre-inoc | No | 6 | 18.0% |
| diluted | | | | | |
| SVH-Evol | 100% | 0.5 d pre-inoc | No | 6 | −70.0% |
| Standard | | | | | |
| SVH-Evol | 25% | 0.5 d pre-inoc | No | 6 | −86.5% |
| diluted | | | | | |
| Armicarb | 0.4% | post-inoc | Yes | 6 | 100% |
| Standard | | | | | |
| Armicarb | 0.04% | post-inoc | Yes | 6 | 72.2% |
| diluted | | | | | |
| SVH-Evol | 100% | post-inoc | Yes | 6 | 97.4% |
| Standard | | | | | |
| SVH-Evol | 25% | post-inoc | Yes | 6 | 73.8% |
| diluted | | | | | |

The results on disease incidence obtained in EXAMPLE 2 are summarised in Table 4 below:

| | | | | | Average |
|---|---|---|---|---|---|
| | | | | | disease |
| Treatment | Conc. | Inoculation | Rain | Number | incidence |
| Blind control | N/A | | N/A | 6 | |
| H2O | | | | | |
| Kocide Opti | 0.1% | 0.5 d pre-inoc | No | 6 | 66.5% |
| Standard | | | | | |
| Kocide Opti | 0.01% | 0.5 d pre-inoc | No | 6 | 58.7% |
| diluted | | | | | |
| SVH-Evol | 100% | 0.5 d pre-inoc | No | 6 | 41.3% |
| Standard | | | | | |
| SVH-Evol | 25% | 0.5 d pre-inoc | No | 6 | 33.0% |
| diluted | | | | | |
| Kocide Opti | 0.1% | 0.5 d pre-inoc | No | 6 | 100.0% |
| Standard | | | | | |
| Kocide Opti | 0.01% | 0.5 d pre-inoc | No | 6 | 5.0% |
| diluted | | | | | |
| SVH-Evol | 100% | 0.5 d pre-inoc | No | 6 | 5.0% |
| Standard | | | | | |
| SVH-Evol | 25% | 0.5 d pre-inoc | No | 6 | −14.5% |
| diluted | | | | | |
| Armicarb | 0.4% | post-inoc | Yes | 6 | 100.0 |
| Standard | | | | | |
| Armicarb | 0.04% | post-inoc | Yes | 6 | 35.8% |
| diluted | | | | | |
| SVH-Evol | 100% | post-inoc | Yes | 6 | 91.6% |
| Standard | | | | | |
| SVH-Evol | 25% | post-inoc | Yes | 6 | 37.0% |
| diluted | | | | | |

In summary, it can thus be said that the plant protecting agent according to the invention shows an efficacy of 81.4% against the plant pathogen Venturia inaequalis. Furthermore, it has been shown that, even when diluted to a quarter of this concentration recommended for use, an efficacy of 51.7% is still achieved against the plant pathogen Venturia inaequalis.

When the tested plant protecting agents were applied or sprayed two days before inoculation, only a slight loss of activity was observed, i.e. the tested plant protecting agent “SVH-Evo1” according to the invention showed a reduction in effectiveness comparable to the copper-containing reference product “Kocide Opti” or “Armicarb”.

Thus, based on EXAMPLE 2, it could be shown that the plant protecting agent according to the invention can be used effectively against apple scab, i.e. against the plant pathogen Venturia inaequalis, and that it has an efficacy comparable to the reference products “Kocide Opti” and “Armicarb”.

A further exemplary preferred composition of the plant protecting agent according to the invention is as follows:

TABLE 7

| Component | Content |
|---|---|
| Fraction A (tea tree plant) | 25 g to 65 g |
| Fraction B (cannabis plant) | 30 g to 70 g |
| Fraction D (green and/or white lavender) | 25 g to 70 g |
| Fraction C (distilled water) | 1,000 ml |

As an alternative to the use of the entire green and/or white lavender plant, it is conceivable that 0.21 g to 30 g of the extracted oil of the green and/or white lavender (Lavandula viridis) is used in respect of fraction D.

A further exemplary preferred composition of the plant protecting agent according to the invention is as follows:

TABLE 8

| Component | Content |
|---|---|
| Fraction A (tea tree plant) | 25 g to 65 g |
| Fraction B (cannabis plant) | 30 g to 70 g |
| Fraction E (true lavender) | 25 g to 70 g |
| Fraction C (distilled water) | 1,000 ml |

As an alternative to the use of the whole true lavender plant, it is conceivable that 0.21 g to 30 g of the extracted oil of true lavender (Lavandula angustifolia) is used in respect of fraction E.

1-11. (canceled)

12. A plant protecting agent for combatting plant pathogens comprising an active substance soluble in water, comprising:
as active substances, a first fraction (A) based on the cannabis plant (Cannabis Sativa L.) and a second fraction (B) based on the tea tree plant (Melaleuca alternifolia), and a third fraction (C), in particular distilled water, the first and second fractions (A; B) being present in the third fraction (C) as an extract.

13. The plant protecting agent according to claim 12, wherein fraction (A) is provided in a ratio to fraction (B) of between 40 and 60 to 1, more preferably in a ratio of between 45 and 55 to 1, most preferably in a ratio of between 45 and 54 to 1.

14. The plant protecting agent according to claim 12, wherein the plant protecting agent acts as a fungicide, in particular against the plant pathogenic fungi Venturia inaequalis (apple scab) and/or Plasmopara viticola (downy mildew).

15. The plant protecting agent according to claim 12, further comprising a wetting agent, the wetting agent comprising a plant oil derivative, in particular a hydrogenated or hardened plant oil derivative, in particular a rapeseed oil derivative or the like.

16. A plant protecting agent according to claim 12, further comprising, as active substances, a further fourth fraction (D) based on green and/or white lavender (Lavandula viridis), the first, second and fourth fractions (A; B, D) being present in the third fraction (C) as an extract.

17. The plant protecting agent according to claim 16, wherein the plant protecting agent alternatively or additionally comprises a further fifth fraction (E) based on true lavender (Lavandula angustifolia), the first, second and fifth fractions (A; B, E) being present in the third fraction (C) as an extract.

18. A process for preparing a plant protecting agent, comprising the process steps:
a) providing a first fraction (A) based on a cannabis plant and a second fraction (B) based on a tea tree plant;
b) comminuting the first and second fractions (A) and (B) to a predetermined degree of grinding, for example with the aid of a mortar or the like, and transferring them into a container;
c) adding a third fraction (C) of a liquid, in particular distilled water;
d) allowing the mixture obtained in process step c) to stand for a predetermined extraction period, preferably, in particular in a cold extraction process, of more than 15 days, preferably between 18 and 60 days, most preferably between 3 and 6 weeks or 21 and 42 days;
e) separating the solid, undissolved constituents of the first and second fractions (A) and (B) from the mixture obtained in process step d), for example with the aid of a sieve and/or a mechanical press;
so that a cold extraction process for obtaining the plant protecting agent in the form of a cold extract based on the cannabis plant as well as on the tea tree plant is realised.

19. The process according to claim 18, wherein in process step d) the mixture is moved or circulated at least once or twice a day for 2 to 3 minutes.

20. The process according to claim 18, wherein the process step e) comprises two successive steps, in which first the dissolved, liquid constituents of the mixture obtained in process step d) are transferred through a fine sieve into a further container and then the remaining, substantially solid constituent of the mixture obtained in process step d) is separated from additional dissolved, liquid constituents by means of a press, in particular a mechanical or hydraulic press, and is transferred into the further container.

21. The process according to claim 18, wherein a fourth fraction (D) based on green and/or white lavender (Lavandula viridis) is additionally provided or comminuted in process steps a) and b).

22. The process according to claim 21, wherein in process steps a) and b) additionally a fifth fraction (E) based on true lavender (Lavandula angustfolia) is comprised, the first, second and fifth fractions (A; B; E) being present in the third fraction (C) as an extract.

23. The plant protecting agent according to claim 13, wherein the plant protecting agent acts as a fungicide, in particular against the plant pathogenic fungi Venturia inaequalis (apple scab) and/or Plasmopara viticola (downy mildew).

24. The plant protecting agent according to claim 13, further comprising a wetting agent, the wetting agent comprising a plant oil derivative, in particular a hydrogenated or hardened plant oil derivative, in particular a rapeseed oil derivative or the like.

25. The plant protecting agent according to claim 14, further comprising a wetting agent, the wetting agent comprising a plant oil derivative, in particular a hydrogenated or hardened plant oil derivative, in particular a rapeseed oil derivative or the like.

26. A plant protecting agent according to claim 13, further comprising, as active substances, a further fourth fraction (D) based on green and/or white lavender (Lavandula viridis), the first, second and fourth fractions (A; B, D) being present in the third fraction (C) as an extract.

27. A plant protecting agent according to claim 14, further comprising, as active substances, a further fourth fraction (D) based on green and/or white lavender (Lavandula viridis), the first, second and fourth fractions (A; B, D) being present in the third fraction (C) as an extract.

28. A plant protecting agent according to claim 15, further comprising, as active substances, a further fourth fraction (D) based on green and/or white lavender (Lavandula viridis), the first, second and fourth fractions (A; B, D) being present in the third fraction (C) as an extract.

29. The process according to claim 19, wherein the process step e) comprises two successive steps, in which first the dissolved, liquid constituents of the mixture obtained in process step d) are transferred through a fine sieve into a further container and then the remaining, substantially solid constituent of the mixture obtained in process step d) is separated from additional dissolved, liquid constituents by means of a press, in particular a mechanical or hydraulic press, and is transferred into the further container.

30. The process according to claim 19, wherein a fourth fraction (D) based on green and/or white lavender (Lavandula viridis) is additionally provided or comminuted in process steps a) and b).

31. The process according to claim 20, wherein a fourth fraction (D) based on green and/or white lavender (Lavandula viridis) is additionally provided or comminuted in process steps a) and b).
